(19) United States
(12) Patent Application Publication
(10) Pub. No.: US 2023/0030168 A1
(43) Pub. Date: Feb. 2, 2023

(54) PROTECTION OF I/O PATHS AGAINST NETWORK PARTITIONING AND COMPONENT FAILURES IN NVME-OF ENVIRONMENTS

(71) Applicant: DELL PRODUCTS L.P., Round Rock, TX (US)

(72) Inventors: Balaji RAJAGOPALAN, Sunnyvale, CA (US); Pawan Kumar SINGAL, Milpitas, CA (US); Erik SMITH, Douglas, MA (US); Joseph LaSalle WHITE, San Jose, CA (US); Claudio DESANTI, Santa Cruz, CA (US)

(73) Assignee: DELL PRODUCTS L.P., Round Rock, TX (US)

(21) Appl. No.: 17/386,428

(22) Filed: Jul. 27, 2021

(51) Int. Cl. H04L 29/08; G06F 13/42; G06F 16/23; G06F 16/245

(52) U.S. Cl. CPC H04L 67/1097; G06F 13/4282; G06F 16/2379; G06F 16/245

(57) ABSTRACT

A Centralized Discovery Controller (CDC) uses built-in intelligence to determine or estimate whether a connection with a non-volatile memory express (NVMe) entity has been discontinued intentionally or whether a connection loss is rather transient, e.g., due to a temporary network issue. In the former case, the CDC sends out asynchronous event notifications (AENs) and communicates the absence of the NVMe entity in a get log page to indicate an administrative access control action, e.g., a user intervention due to a zoning change or the removal of an entity due to a hardware failure. In the latter case, the CDC creates an “unreachable” entry in the name server database that indicates a CDC connectivity failure but maintains the entity in the name server database despite the connection loss, refraining from sending out notifications to relevant (or impacted) entities to increase bandwidth, traffic stability, and network availability.

### BACKGROUND

### A. Technical Field

The present disclosure relates generally to information handling systems. More particularly, the present disclosure relates to protecting input/output (I/O) paths against network partitioning and component failures in non-volatile memory express over fabric (NVMe-oF) environments.

### B. Background

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use, such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A Centralized Discovery Controller (CDC) in an IP SAN operating in a standalone mode, e.g., as a virtual machine (VM) on a hypervisor, may lose connectivity to an NVMe entity, such as a host or subsystem for a number of reasons, including network partitioning and component failures on client, server, or networking infrastructure. Once connectivity is lost, if the CDC were to simply remove the NVMe entity from its name server data base, the CDC would send out asynchronous event notifications (AENs) to all relevant entities in the IP SAN. Each impacted entity would then query the name server for the latest information using a Get Log Page command. Upon receiving a response to the query, so-called “well-behaved” NVMe entities may take note of missing NVMe entities in the Get Log Page response and, acting in accordance with existing NVMe protocols, drop open connections with said entities.

Oftentimes, a loss of the connectivity from a CDC to an NVMe entity caused by a control plane issue, such as loss of a TCP connectivity to a particular IP address, is transient in nature. Therefore, simply removing an NVMe entity from the name server each time connectivity is lost negatively impacts traffic in the I/O path between the host and the subsystem, resulting in unnecessary churn in the network. Under certain circumstances, churn may lead to highly undesirable denial-of-service type scenarios.

In comparison, in FC-based SANs, a loss of connectivity between an end-device and a switch automatically results in an immediate removal from the name server since the name server is distributed and operates on the switch where the end-device is attached. As a result, a loss of connectivity always indicates that the end-device is unreachable and that no connection to it should be attempted.

Today, there exist no solutions for the above-mentioned problem for IP-based fabrics that are used for transporting NVMe traffic. Accordingly, it is highly desirable to find new, more efficient ways for IP-based fabrics to increase bandwidth and network availability by reducing unwanted I/O churn, i.e., oftentimes unintended, temporary loss of open connections that must be dropped.

### BRIEF DESCRIPTION OF THE DRAWINGS

References will be made to embodiments of the disclosure, examples of which may be illustrated in the accompanying figures. These figures are intended to be illustrative, not limiting. Although the accompanying disclosure is generally described in the context of these embodiments, it should be understood that it is not intended to limit the scope of the disclosure to these particular embodiments. Items in the figures may not be to scale.

FIG. 1 depicts an NVMe-oF zone in a SAN that comprises a CDC.

FIG. 2 depicts connections between a host and subsystems implemented by the zoning configuration according to FIG. 1.

FIG. 3 depicts a scenario in which a storage is unreachable from the CDC shown in FIG. 1, according to embodiments of the present disclosure.

FIG. 4 depicts the result of an exemplary administrative update to a zone according to embodiments of the present disclosure.

FIG. 5 depicts connections between a host and subsystems, according to the zoning in FIG. 4, according to embodiments of the present disclosure.

FIG. 6 depicts a scenario in which host A is unreachable from the CDC, according to embodiments of the present disclosure.

FIG. 7 depicts a flowchart illustrating a process for reducing I/O churn in a SAN, according to embodiments of the present disclosure.

FIG. 8 depicts a flowchart illustrating another process for reducing I/O churn in a SAN, according to embodiments of the present disclosure.

FIG. 9 depicts a simplified block diagram of an information handling system, according to embodiments of the present disclosure.

FIG. 10 depicts an alternative block diagram of an information handling system, according to embodiments of the present disclosure.

### DETAILED DESCRIPTION OF EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system/device, or a method on a tangible computer-readable medium.

Components, or modules, shown in diagrams are illustrative of exemplary embodiments of the disclosure and are meant to avoid obscuring the disclosure. It shall also be understood that throughout this discussion that components may be described as separate functional units, which may comprise sub-units, but those skilled in the art will recognize that various components, or portions thereof, may be divided into separate components or may be integrated together, including, for example, being in a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or any of their derivatives shall be understood to include direct connections, indirect connections through one or more intermediary devices, and wireless connections. It shall also be noted that any communication, such as a signal, response, reply, acknowledgement, message, query, etc., may comprise one or more exchanges of information.

Reference in the specification to “one or more embodiments,” “preferred embodiment,” “an embodiment,” “embodiments,” or the like means that a particular feature, structure, characteristic, or function described in connection with the embodiment is included in at least one embodiment of the disclosure and may be in more than one embodiment. Also, the appearances of the above-noted phrases in various places in the specification do not necessarily all refer to the same embodiment or embodiments.

The use of certain terms in various places in the specification is for illustration and should not be construed as limiting. The terms “include,” “including,” “comprise,” and “comprising” shall be understood to be open terms, and any examples are provided by way of illustration and shall not be used to limit the scope of this disclosure.

A service, function, or resource is not limited to a single service, function, or resource; usage of these terms may refer to a grouping of related services, functions, or resources, which may be distributed or aggregated. The use of memory, database, information base, data store, tables, hardware, cache, and the like may be used herein to refer to system component or components into which information may be entered or otherwise recorded. The terms “data,” “information,” along with similar terms, may be replaced by other terminologies referring to a group of one or more bits, and may be used interchangeably. The terms “packet” or “frame” shall be understood to mean a group of one or more bits.

In one or more embodiments, a stop condition may include: (1) a set number of iterations that has been performed; (2) an amount of processing time has been reached; (3) convergence (e.g., the difference between consecutive iterations is less than a first threshold value); (4) divergence (e.g., the performance deteriorates); and (5) an acceptable outcome has been reached.

It shall be noted that although embodiments described herein may be within the context of SANs, aspects of the present disclosure are not so limited. Accordingly, the aspects of the present disclosure may be applied or adapted for use in other contexts. The term “administrator” may represent any user, such as a network administrator, storage administrator, or other managing entity. The terms “unreachable” and “offline” may be used interchangeably.

Zone management allows a SAN administrator to define access control rules that control communication between host and subsystem interfaces, e.g., such that a host can discover storage ports that it can access. Zoning typically involves creating zones that comprise zone members and that may overlap, i.e., a member of one zone can be a member of any number of other zones. Zone members are allowed to communicate with each other according to their zone membership. Name server entries are filtered to ensure only entities allowed to communicate are returned. When soft zoning methods are employed, the network does not prevent access, and hosts are not prevented from connecting to any subsystem interface. In contrast, when hard zoning is used as the preferred method of zoning, the network does prevent unauthorized access, such that a host can only connect to specific subsystem interfaces with which the host shares a common zone.

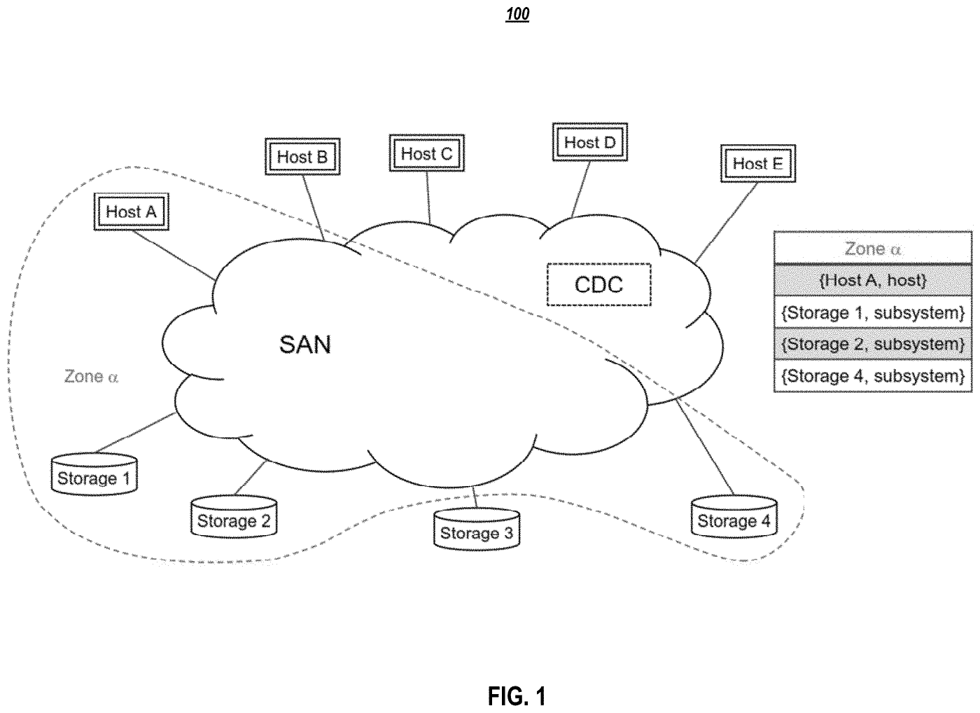

FIG. 1 depicts an NVMe-oF zone in a SAN that comprises a CDC. SAN 100 in FIG. 1 contains NVMe entities hosts A through E, subsystems storage 1 through 4, a zone named α, which comprises members host A, and storage 1, 2, and 4. Thus, storage 3 is not a member of zone α. FIG. 1 further comprises a CDC, which in operation provides a centralized management interface for the control of the NVMe entities within SAN 100.

The CDC, is typically configured and maintained by an administrator and contains a database that stores zoning information, which defines any number of zones, zone members for each zone, and access control configurations according to zone membership. An administrator can access the CDC to configure zones, e.g., via a management interface (not shown), such as the management interface of one of storage devices 1 through 4.

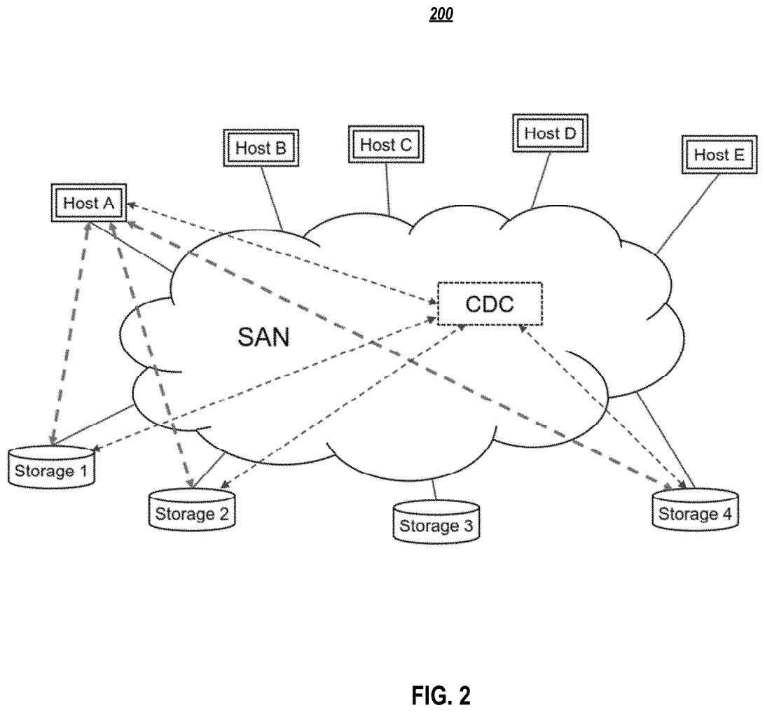

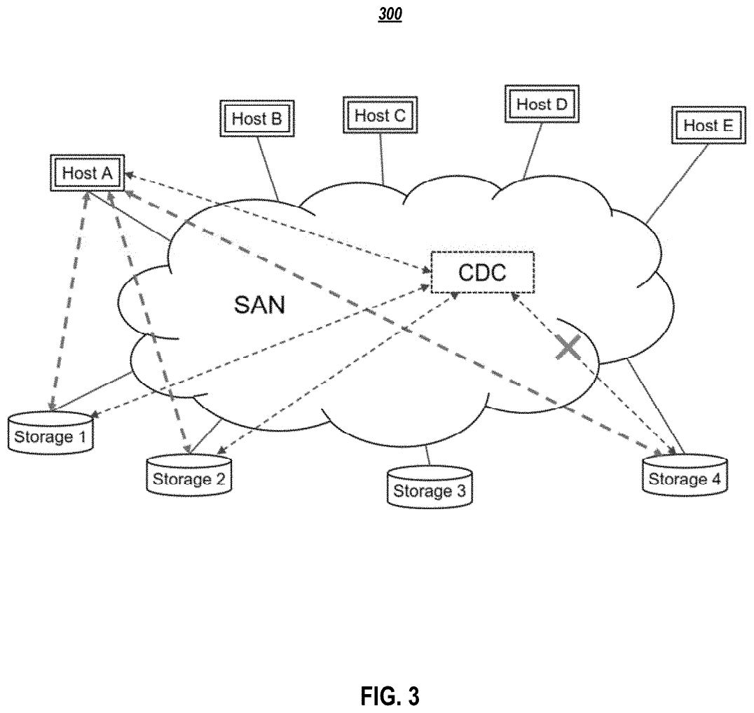

FIG. 2 depicts connections between a host and subsystems as implemented by the zoning according to FIG. 1. Host A can communicate with storage 1, storage 2, and storage 4, but not with storage 3. In contrast, the CDC can communicate with host A and all storage elements in FIG. 2 that the CDC is connected to. The CDC may enable communication between host and storage devices by using a number of explicit or implicit registration features according to an NVMe protocol and according to zoning rules in the NVMe zoned fabric. Once the CDC detects a change to a subsystem, it communicates the change to host A using an AEN. Host A may receive the appropriate information, typically in response to a Get Log Page, and may act upon the information. It is noted that some existing NVMe standards dictate what a host or subsystem is supposed to do after losing a connection with a CDC, namely, act according to the information in the Get Log Page response. Various embodiments herein consider scenarios in which a CDC loses a connection with a host or subsystem. For example, FIG. 3 depicts a scenario in which storage 4 is unreachable from the CDC.

Once storage 4 in FIG. 3 becomes unreachable from the CDC, according to existing protocols, the CDC would send out an AEN to host A to indicate that the CDC lost its communication with storage 4. As a result, host A may, in response to not being able to find storage 4 in a Get Log Page response, drop its connection to storage 4. However, because the connection (i.e., the I/O path between host A and storage 4) is technically still available, it would be desirable if host A could continue to maintain its previously established connection with storage 4 rather than having to drop it and causing unwanted disruption in SAN 100.

Various embodiments herein, allow to maintain connections in data paths, e.g., between a host and a subsystem, where there is no operational problem with the data path itself. Advantageously, this reduces churn and disruption in a network, such as SAN 100.

In detail, in one or more embodiments, once a connection from an NVMe entity, such as a host or subsystem, to a CDC is established via any means, e.g., as defined by an NVMe-oF specification (e.g., TP8010), an action, which may be made the default action, is to retain successfully established connections irrespective of a subsequent loss of connectivity with the CDC. Unlike conventional methods that immediately purge NVMe entities from the SAN as soon as connectivity is lost, one or more embodiments herein operate under the assumption that a detected connectivity loss is temporary, e.g., due to ongoing maintenance or similar reasons, and that the connection will be restored in a reasonable amount of time. Herein, such connections are referred to as “sticky” connections.

In one or more embodiments, once a CDC detects a loss of connectivity to an NVMe entity, e.g., the loss of a TCP connection between the CDC and a host or subsystem, the CDC may mark (e.g., in a name server database) those entries that are not reachable as unreachable, rather than removing them. Further, the CDC may withhold generating an AEN that otherwise would solicit a query from impacted entities, e.g., by using a Get Log Page command. For example, in response to an NVMe entity initiating a Get Log Page, e.g., a host that restarts its operation and asks the CDC to list all storage that the host can connect to, the CDC may return all NVMe entities that have been zoned with the querying NVMe entity, irrespective of the CDCs potentially temporary inability to establish a connection with the NVMe entity at that point in time.

In one or more embodiments, entries in a name server database in the CDC that comprise sticky connections may remain in the name server database until the default action is overridden, e.g., by the occurrence of one or more conditions or events, such as an NVMe entity expressly terminating a service that it no longer wants to provide or consume, or until the CDC interprets a lack of communication by an NVMe entity that lasts a certain period of time as an intent by a host or a subsystem as not wanting to provide or consume a service. Once such a condition is present, or such an event has occurred, the CDC may resume sending out AENs to impacted entities to purge information associated with stale entities from its database. Other non-limiting examples of events or conditions for manually or automatically purging entities comprise the following:

(1) a host or subsystem explicitly disconnecting an NVMe entity, e.g., by deregistering it with a CDC or otherwise communicating a termination request according to a network protocol;

(2) detecting a CDC name server move, e.g., based on link layer discovery protocol, multicast domain name system (mDNS) activity, or media access control learning. When the CDC is operating in standalone mode on a virtual appliance, the detection may be based on mDNS activity or by polling networking management data bases on third party switches;

(3) an NVMe entity being replaced on a same physical switch port, which may be detected, e.g., based on LLDP protocol, mDNS activity, or MAC learning. When the CDC is operating in standalone mode on a virtual appliance, the detection may be based on mDNS activity or by polling networking management data bases on third party switches;

(4) forced removal, e.g., by a user explicitly removing an NVMe entity from the CDC name server database;

(5) deletion from a zone database, e.g., by an administrator deleting an NVMe entity reference from all configured zone databases or making related zoning policy changes; or

(6) deletion based on time out, e.g., by a user specifying a timeout value, such that once a CDC loses a connection with an NVMe entity, the CDC may wait according to a pre-configured time-out value prior to removing an offline entry from the CDC.

In one or more embodiments, once the CDC detects the name server has been moved, replaced, forcibly removed, deleted from a zone database, or has timed out, the CDC may send AENs to impacted entities so that when the name server entities such as zone members query the CDC, the get log page response no longer contains the disconnected entities.

In summary, in one or more embodiments herein, a CDC may use built-in intelligence to determine or estimate whether a connection with an NVMe entity, such as a host or subsystem, has been intentionally discontinued, e.g., by user intervention or by the NVMe entity itself initiating removal from a name server database, or whether a connection loss is rather transient, e.g., due to a temporary network issue. In the former case, the CDC may send out notifications, e.g., in the form of AENs and communicate the change, i.e., the absence of the NVMe entity, in a Get Log Page response. In the latter case, the CDC may maintain the entity in the name server database despite the connection loss, refraining from sending out notifications to relevant (or impacted) entities to reduce I/O churn and, optionally, communicate to NVMe entities information regarding its ability to reach an entity in its name server (e.g., via a Get Log Page request), such that the impacted NVMe entities may take appropriate action depending on their particular implementation.

Returning to FIG. 3, assuming that the CDC has lost communication, e.g., a TCP connection, with storage 4, instead of removing storage 4 from its database and sending out an AEN to host A to indicate its loss of communication according to standard NVMe protocol, which would cause host A to drop its connection to storage 4 the CDC may perform one or more of the following:

In one or more embodiments, the CDC may, e.g., as a default action, generate a sticky entry, or mark an entry as a sticky entry, e.g., according to a policy that may be implemented in an existing protocol (e.g., as a protocol extension), or it may be included in protocols developed in the future. The CDC may use an “unreachability” bit, “unreachable from CDC” bit, or similar, to flag in a database that storage 4 is unreachable or offline and not send out an AEN. In one or more embodiments, the CDC in FIG. 3 may mark storage 4 as “sticky” to indicate that the CDC will not remove storage 4 from the database in the event of the connection between the CDC and storage 4 being lost.

In one or more embodiments, the CDC may then send an AEN to host A to cause host A to issue a Get Log Page command and, in response to receiving the Get Log Page command, the CDC may return a log page response that comprises the name server entry “unreachable” for storage 4.

In addition, once the CDC indicates that storage 4 is not reachable, host A may react in various ways. For example, if host A's connection with storage 4 is still operational, host A, having received the name server entry for storage 4, advantageously, may continue to perform I/O operations with storage 4 using the existing connection rather than dropping it and causing I/O churn. In short, absent an indication that any of the subsystems, here, storage 1, 2, and 4 intended to disconnect, the CDC may communicate to host A that host A may continue to detect and directly communicate with storage 1, 2, and 4, even if the CDC is unable to reach storage 4, in effect, assuming that the data path between host A and storage 4 is intact and operational and that the loss of connection is temporary.

It is noted that although an unreachability bit may be purely informational in that it does not carry any expectations on how a notified NVMe entity should act, in one or more embodiments, the information, e.g., in connection with information provided by a host (or a subsystem acting as a host), may be used as a debugging tool, e.g., to narrow down a particular NVMe entity and/or its data paths as the most likely source(s) of a detected CDC connectivity failure. In addition, a sticky entry or other notification by the CDC may comprise information that may be used to directly communicate the content of what has changed in the database, e.g., which NVMe entity has lost communication or went offline. In one or more embodiments, entries may be purged, e.g., by unflagging, removing, or changing a bit in the database, e.g., by a networking component that is different from the CDC and according to a policy, configuration setting, as part of a maintenance procedure.

In addition, as discussed next, the introduction of an unreachability entry in a log page, advantageously, enables a host to distinguish between a CDC connectivity failure and an administrative access control action.

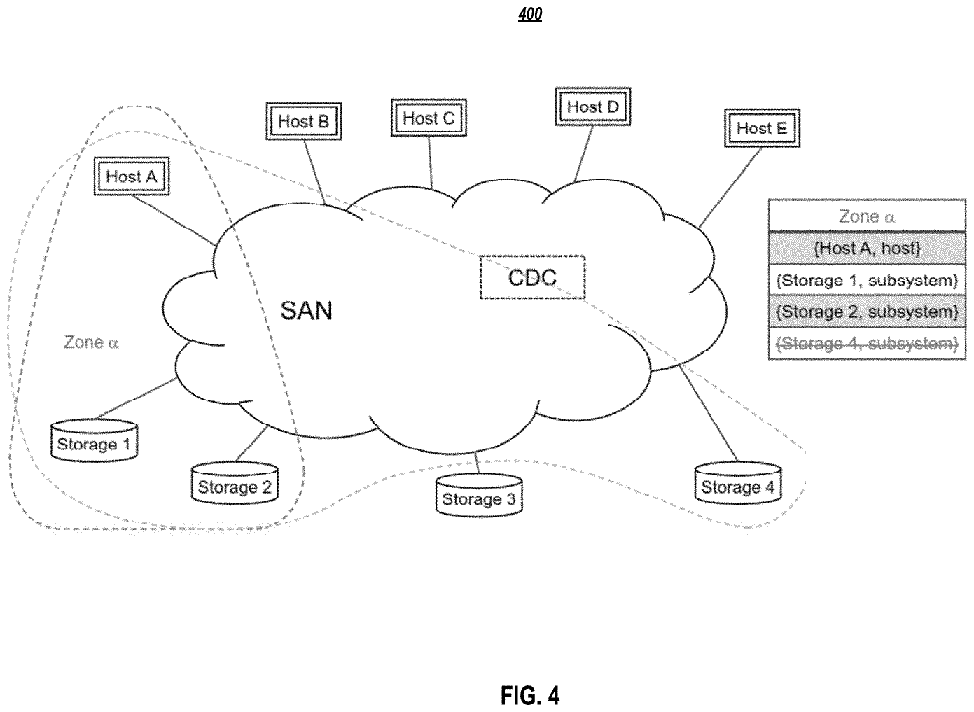

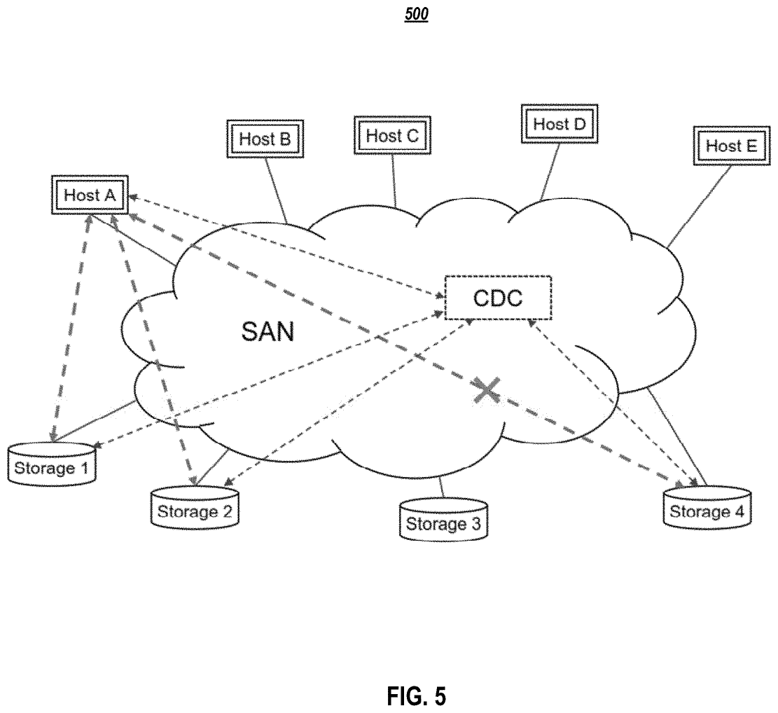

FIG. 4 depicts the result of an administrative update to zone a according to embodiments of the present disclosure. The example indicates that an administrator has reconfigured zone a to disable host A access to storage 4 through zoning. Since zone a no longer contains storage 4, host A, storage 1, and storage 2 are now the only remaining zone members. The resulting connections between host and connections between host A are depicted in FIG. 5, which illustrates that host A can no longer communicate with storage 4 according to the zoning shown in FIG. 4.

In one or more embodiments, the CDC in FIG. 5 may send an AEN to host A, which may issue a Get Log Page command to the CDC. The CDC may then return a Get Log Page response that does not include an entry for storage 4, i.e., indicating that an administrative access control action has occurred and/or that host A should cease I/O operations with storage 4.

It is noted that, just like entries indicating unreachability, the lack of an entry for storage 4 may be merely informational. In one or more embodiments, a flag in a host registration may be used to indicate to the CDC how the host reacts to administrative access control actions. As a person of skill in the art will appreciate, if an administrator wishes to ensure that a host disconnects from a subsystem (or vice versa) to cease I/O operations, e.g., upon detecting an administrative access control action, hard zoning methods may be implemented to enforce the desired behavior, e.g., to prevent unauthorized access.

In one or more embodiments, the CDC in FIG. 5 may further send an AEN to storage 4, which may issue a Get Log Page command to the CDC. And the CDC may return a Get Log Page response that does not include an entry for host A, again, indicating that an administrative access control action has occurred and that storage 4 should cease I/O operations with host A. In one or more embodiments, to ensure that host A indeed ceases I/O operations with storage 4, e.g., if host A is not a well-behaved host that does not disconnect from storage 4 upon detecting an administrative access control action, hard zoning may be employed to stop I/O connections between host A and storage 4. It is understood that the CDC need not communicate to a non-well-behaved host A any information regarding the CDC's ability to reach a subsystem in its name server.

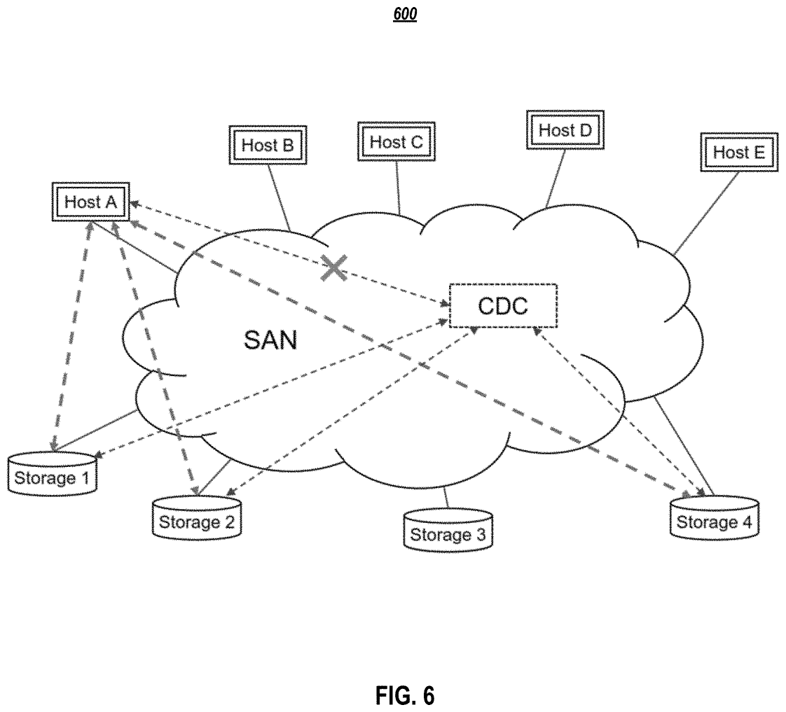

FIG. 6 depicts using embodiments of the present disclosure in an exemplary scenario in which host A is unreachable from the CDC. In one or more embodiments, once host A goes down and the CDC loses communication with host A, the CDC may mark the name server entry of host A as sticky, indicating that the CDC will not remove host A from the database in the event of the connection to host A being lost. The CDC may then send an AEN to storage 1, 2, and 4. In one or more embodiments, once storage 1, 2, and 4 issue a get log page command to the CDC, the CDC may return a log page response that comprises the name server entry unreachable (or equivalent) for host A. If host A's connection with any of storage 1, 2, and 4 is still operational, host A, may continue to perform I/O operations with storage 1, 2, and 4 using any previously established connection(s).

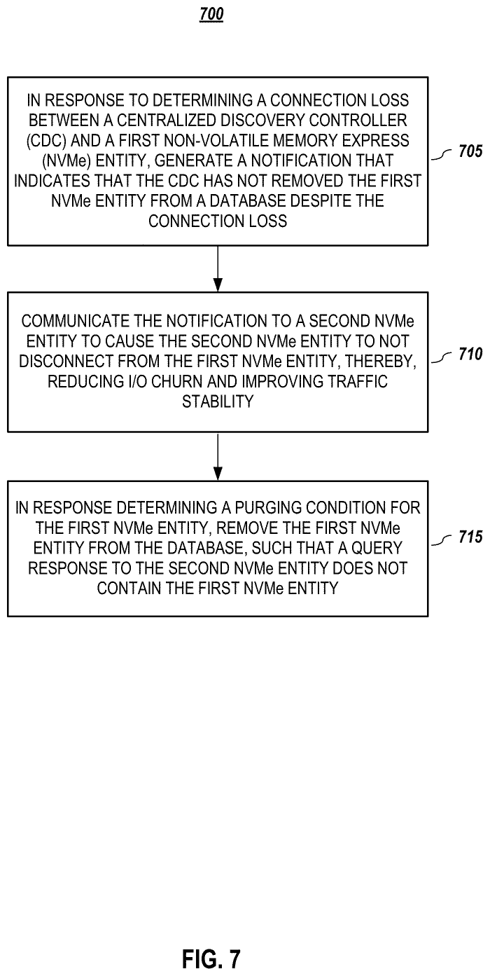

FIG. 7 depicts a flowchart illustrating a process for reducing I/O churn in a SAN, according to embodiments of the present disclosure. In one or more embodiments, process 700 for reducing I/O churn may begin when, in response to a CDC in a SAN detecting or otherwise determining a connection loss between the CDC and a first NVMe entity, a notification is generated (705). The notification indicates that the CDC has not or will not remove the first NVMe entity from its database despite the loss in connection. In one or more embodiments, the notification may be communicated (710) to a second NVMe entity to indicate cause the second NVMe entity to not disconnect from the first NVMe entity, thereby, reducing I/O churn and improving traffic stability. In response to determining a purging condition for the first NVMe entity, the CDC may remove (715) the first NVMe entity from its database, such that a query response, made by the CDC in response to a query by the second NVMe entity, does not contain the first NVMe entity.

It shall be noted that: (1) certain steps herein may optionally be performed; (2) steps may not be limited to the specific order set forth herein; (3) certain steps may be performed in different orders; and (4) certain steps may be done concurrently.

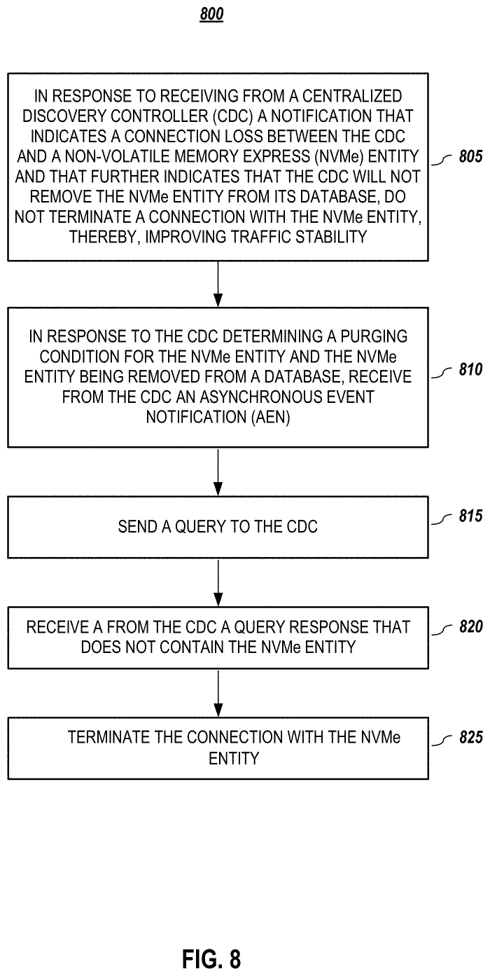

FIG. 8 depicts a flowchart illustrating another process for reducing I/O churn in a SAN, according to embodiments of the present disclosure. In one or more embodiments, process 800 for reducing churn may begin when, in response to receiving from a CDC a notification that indicates a connection loss between the CDC and an NVMe entity and that further indicates that the CDC will not remove the NVMe entity from its database, a connection with the NVMe entity is not terminated (805), thereby, reducing I/O churn and improving traffic stability.

In one or more embodiments, in response to the CDC determining a purging condition for the NVMe entity and the NVMe entity being removed from a database, an AEN may be received (810) from the CDC.

In one or more embodiments, a query may be sent (815) to the CDC. And a query response that does not contain the NVMe entity may be received (820).

Finally, the connection with the NVMe entity may be terminated (825).

In one or more embodiments, aspects of the present patent document may be directed to, may include, or may be implemented on one or more information handling systems (or computing systems). An information handling system/computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, mobile device (e.g., personal digital assistant (PDA), smart phone, phablet, tablet, etc.), smart watch, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, read only memory (ROM), and/or other types of memory. Additional components of the computing system may include one or more drives (e.g., hard disk drives, solid state drive, or both), one or more network ports for communicating with external devices as well as various input and output (I/O) devices, such as a keyboard, mouse, stylus, touchscreen, and/or video display. The computing system may also include one or more buses operable to transmit communications between various hardware components.

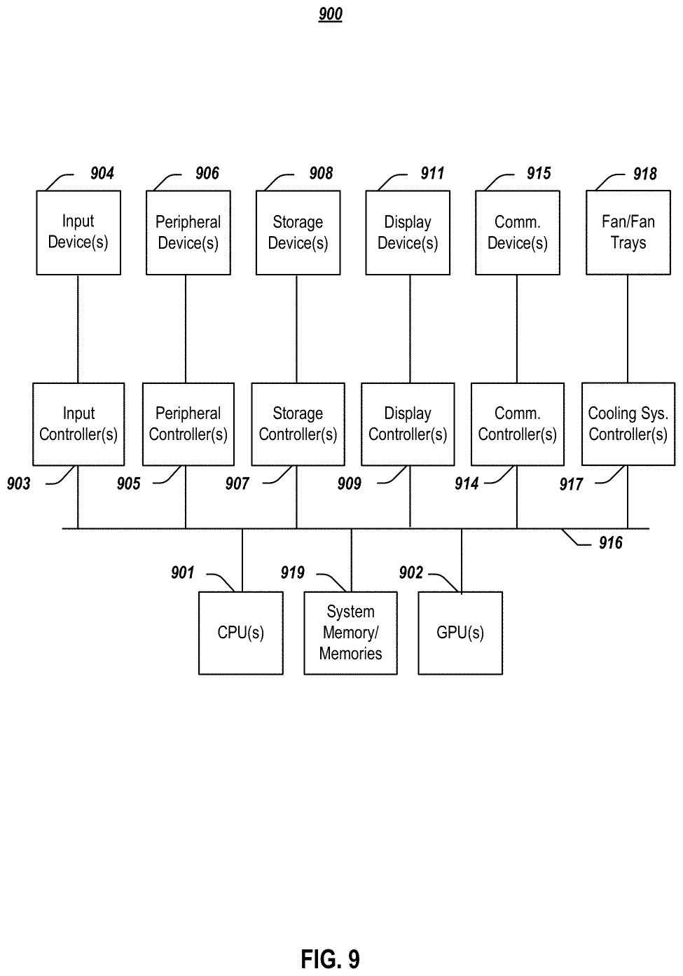

FIG. 9 depicts a simplified block diagram of an information handling system (or computing system), according to embodiments of the present disclosure. It will be understood that the functionalities shown for system 900 may operate to support various embodiments of a computing system—although it shall be understood that a computing system may be differently configured and include different components, including having fewer or more components as depicted in FIG. 9.

As illustrated in FIG. 9, the computing system 900 includes one or more CPUs 901 that provides computing resources and controls the computer. CPU 901 may be implemented with a microprocessor or the like and may also include one or more graphics processing units (GPU) 902 and/or a floating-point coprocessor for mathematical computations. In one or more embodiments, one or more GPUs 902 may be incorporated within the display controller 909, such as part of a graphics card or cards. The system 900 may also include a system memory 919, which may comprise RAM, ROM, or both.

A number of controllers and peripheral devices may also be provided, as shown in FIG. 9. An input controller 903 represents an interface to various input device(s) 904, such as a keyboard, mouse, touchscreen, and/or stylus. The computing system 900 may also include a storage controller 907 for interfacing with one or more storage devices 908 each of which includes a storage medium such as magnetic tape or disk, or an optical medium that might be used to record programs of instructions for operating systems, utilities, and applications, which may include embodiments of programs that implement various aspects of the present disclosure. Storage device(s) 908 may also be used to store processed data or data to be processed in accordance with the disclosure. The system 900 may also include a display controller 909 for providing an interface to a display device 911, which may be a cathode ray tube (CRT) display, a thin film transistor (TFT) display, organic light-emitting diode, electroluminescent panel, plasma panel, or any other type of display. The computing system 900 may also include one or more peripheral controllers or interfaces 905 for one or more peripherals 906. Examples of peripherals may include one or more printers, scanners, input devices, output devices, sensors, and the like. A communications controller 914 may interface with one or more communication devices 915, which enables the system 900 to connect to remote devices through any of a variety of networks including the Internet, a cloud resource (e.g., an Ethernet cloud, a Fiber Channel over Ethernet (FCoE)/Data Center Bridging (DCB) cloud, etc.), a local area network (LAN), a wide area network (WAN), a storage area network (SAN) or through any suitable electromagnetic carrier signals including infrared signals. As shown in the depicted embodiment, the computing system 900 comprises one or more fans or fan trays 918 and a cooling subsystem controller or controllers 917 that monitors thermal temperature(s) of the system 900 (or components thereof) and operates the fans/fan trays 918 to help regulate the temperature.

In the illustrated system, all major system components may connect to a bus 916, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable medium including, for example: magnetic media such as hard disks, floppy disks, and magnetic tape; optical media such as compact discs (CDs) and holographic devices; magneto-optical media; and hardware devices that are specially configured to store or to store and execute program code, such as application specific integrated circuits (ASICs), programmable logic devices (PLDs), flash memory devices, other non-volatile memory (NVM) devices (such as 3D XPoint-based devices), and ROM and RAM devices.

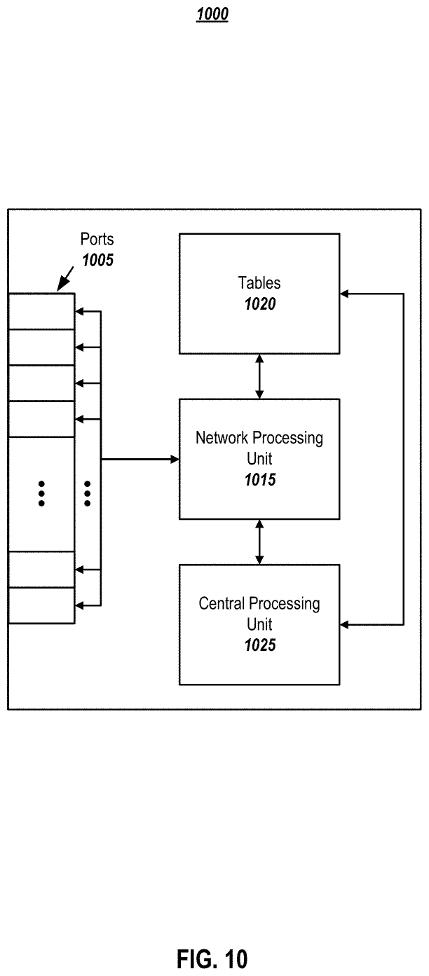

FIG. 10 depicts an alternative block diagram of an information handling system, according to embodiments of the present disclosure. It will be understood that the functionalities shown for system 1000 may operate to support various embodiments of the present disclosure—although it shall be understood that such system may be differently configured and include different components, additional components, or fewer components.

The information handling system 1000 may include a plurality of I/O ports 1005, a network processing unit (NPU) 1015, one or more tables 1020, and a CPU 1025. The system includes a power supply (not shown) and may also include other components, which are not shown for sake of simplicity.

In one or more embodiments, the I/O ports 1005 may be connected via one or more cables to one or more other network devices or clients. The network processing unit 1015 may use information included in the network data received at the node 1000, as well as information stored in the tables 1020, to identify a next device for the network data, among other possible activities. In one or more embodiments, a switching fabric may then schedule the network data for propagation through the node to an egress port for transmission to the next destination.

Aspects of the present disclosure may be encoded upon one or more non-transitory computer-readable media with instructions for one or more processors or processing units to cause steps to be performed. It shall be noted that the one or more non-transitory computer-readable media shall include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that have computer code thereon for performing various computer-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as CDs and holographic devices; magneto-optical media; and hardware devices that are specially configured to store or to store and execute program code, such as ASICs, PLDs, flash memory devices, other NVM devices (such as 3D XPoint-based devices), and ROM and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into modules and/or sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

1. A computer-implemented method for increasing bandwidth and network availability in a storage area network (SAN), the computer-implemented method comprising:
in response to a Centralized Discovery Controller (CDC) in a SAN determining a connection loss between the CDC and a first non-volatile memory express (NVMe) entity, generating a notification that indicates that the CDC will not remove the first NVMe entity from a database despite the connection loss;
communicating the notification to a second NVMe entity causing the second NVMe entity to not disconnect from the first NVMe entity, thereby, improving traffic stability; and
in response to the CDC determining a purging condition for the first NVMe entity, removing the first NVMe entity from the database, such that a query response, made by the CDC in response to a query by the second NVMe entity, does not contain the first NVMe entity.

2. The computer-implemented method of claim 1, wherein the first NVMe entity is a host, the second NVMe entity is a subsystem, the database is a name server database maintained in the CDC, and the notification is at least one of an entry or a flag in the database.

3. The computer-implemented method of claim 1, wherein the notification further indicates that the first NVMe entity is temporarily unreachable due to the connection loss.

4. The computer-implemented method of claim 1, further comprising in response to determining the connection loss, not communicating an asynchronous event notification (AEN) to the second NVMe entity to prevent soliciting the query.

5. The computer-implemented method of claim 1, wherein removing the first NVMe entity from the database is performed by a networking component different from the CDC.

6. The computer-implemented method of claim 5, wherein removing is performed according at least one of a policy, a configuration setting, or a maintenance procedure.

7. The computer-implemented method of claim 1, further comprising in response to determining the purging condition, overriding the notification by sending out an asynchronous event notification (AEN) to the second NVMe entity.

8. The computer-implemented method of claim 1, wherein the purging condition comprises at least one of:
a termination request by the first NVMe entity,
a lack of communication by the first NVMe entity for a period of time, or
detecting by the CDC at least one of:
a name server move,
a replacement of the first NVMe entity on a physical switch port,
a forced removal of the first NVMe entity from a name server database,
a deletion of an NVMe entity reference from a zone database, or
a deletion of the first NVMe entity based on a time out condition.

9. A non-transitory computer-readable medium or media comprising one or more sequences of instructions which, when executed by at least one processor, causes steps to be performed comprising:
in response to receiving from a Centralized Discovery Controller (CDC) a notification that indicates a connection loss between the CDC and a non-volatile memory express (NVMe) entity but that the CDC will not remove the NVMe entity from its database, not terminating a connection with the NVMe entity to improve traffic stability;
in response to the CDC determining a purging condition for the NVMe entity and the NVMe entity being removed from the database, receiving from the CDC an asynchronous event notification (AEN);
sending a query to the CDC;
receiving a from the CDC a query response that does not contain the NVMe entity; and
terminating the connection with the NVMe entity.

10. The non-transitory computer-readable medium or media of claim 9, wherein the CDC removes the NVMe entity from database by performing at least one of unflagging or changing a bit in a name server database.

11. The non-transitory computer-readable medium or media of claim 9, wherein the NVMe entity is removed from the database, according at least one of a policy, a configuration setting, or a maintenance procedure, by a networking component different from the CDC.

12. The non-transitory computer-readable medium or media of claim 9, wherein the notification further indicates that the NVMe entity is temporarily unreachable due to a connectivity failure.

13. The non-transitory computer-readable medium or media of claim 9, further comprising not receiving an AEN in response to determining the connection loss.

14. The non-transitory computer-readable medium or media of claim 9, further comprising receiving an AEN in response to the CDC determining the purging condition.

15. The non-transitory computer-readable medium or media of claim 9, wherein the purging condition comprises at least one of:
a termination request by the first NVMe entity,
a lack of communication by the first NVMe entity for a period of time, or
detecting by the CDC at least one of:
a name server move,
a replacement of the first NVMe entity on a physical switch port,
a forced removal of the first NVMe entity from a name server database,
a deletion of an NVMe entity reference from a zone database, or
a deletion of the first NVMe entity based on a time out condition.

16. A system for increasing bandwidth and network availability in a storage area network, the system comprising:
one or more processors; and
a non-transitory computer-readable medium or media comprising one or more sets of instructions which, when executed by at least one of the one or more processors, causes steps to be performed comprising:
in response to a Centralized Discovery Controller (CDC) in a SAN determining a connection loss between the CDC and a first non-volatile memory express (NVMe) entity, generating a notification that indicates that the CDC will not remove the first NVMe entity from a database despite the connection loss;
communicating the notification to a second NVMe entity causing the second NVMe entity to not disconnect from the first NVMe entity, thereby, improving traffic stability; and
in response to the CDC determining a purging condition for the first NVMe entity, removing the first NVMe entity from the database, such that a query response, made by the CDC in response to a query by the second NVMe entity, does not contain the first NVMe entity.

17. The system of claim 16, wherein the notification further indicates that the first NVMe entity is temporarily unreachable due to a connectivity failure.

18. The system of claim 16, wherein a networking component different from the CDC performs removing according at least one of a policy, a configuration setting, or a maintenance procedure.

19. The system of claim 16, further comprising in response to determining the connection loss not communicating an asynchronous event notification (AEN) to the second NVMe entity to prevent soliciting a query from the second NVMe entity.

20. The system of claim 16, further comprising in response to determining the purging condition, overriding the notification by sending out an asynchronous event notification (AEN) to the second NVMe entity.
